(19) United States
(12) Patent Application Publication
(10) Pub. No.: US 2014/0310858 A1
(43) Pub. Date: Oct. 23, 2014

(54) Convertible Ultraviolet Ray Protective Garment

(71) Applicant: Mari Alexandra KUPIEC, Manhattan Beach, CA (US)

(72) Inventor: Mari Alexandra KUPIEC, Manhattan Beach, CA (US)

(21) Appl. No.: 14/227,776

(22) Filed: Mar. 27, 2014

Related U.S. Application Data
(60) Provisional application No. 61/812,796, filed on Apr. 17, 2013.

(51) Int. Cl. A62B 17/00

(52) U.S. Cl. CPC A62B 17/00
USPC 2/455

(57) ABSTRACT

A convertible ultraviolet ray protective garment provides a user with a garment that protects the user from damaging ultraviolet rays while providing a wide variety of wearing options. A first fastening strip and a second fastening strip positioned opposite each other on a fabric sheet of ultraviolet ray blocking material allows the user to affix the ends of the fabric sheet together in order to configure the garment in any of a variety of arrangements.

The current application claims a priority to the U.S. Provisional Patent application Ser. No. 61/812,796 filed on Apr. 17, 2013.

### FIELD OF THE INVENTION

The present invention relates generally to an article of clothing for wearing around a body part of an individual.

### BACKGROUND OF THE INVENTION

Clothing is a fiber and textile material worn on the body. The wearing of clothing is mostly restricted to human beings and is a feature of nearly all human societies. The amount and type of clothing worn is dependent on physical stature, gender, as well as social and geographic considerations.

Physically, clothing serves many purposes: it can serve as protection from the elements, and can enhance safety during hazardous activities such as hiking and cooking. It protects the wearer from rough surfaces, rash-causing plants, insect bites, splinters, thorns and prickles and the sun's radiation by providing a barrier between the skin and the environment. Clothes can insulate against cold or hot conditions. Further, they can provide a hygienic barrier, keeping infectious and toxic materials away from the body. Clothing also provides protection from harmful UV radiation. Clothes can be made out of fiber plants such as cotton, plastics such as polyester, or animal skin and hair such as wool. Humans began wearing clothes roughly 83,000 to 170,000 years ago.

Many different types of clothing exist. Clothing accessories, such as scarves, shawls, and the like, typically comprise of a single piece of elongated and rectangular material that is worn around a wearer's neck. Different environments often tend to call for different clothing types or clothing accessories. In day-to-day activities, an individual may traverse several different environments and desire to change between clothing types or accessories accordingly. One very common environment for people to be in is outside, in direct exposure to the sun's rays. This may be an undesirable condition for many individuals who wish to protect their skin from sun exposure. It is therefore an object of the present invention to introduce a garment that provides protection from the ultraviolet rays of the sun and can be converted into various different garments.

### BRIEF DESCRIPTION OF THE DRAWINGS

FIG. 1 is a front view of the present invention.

FIG. 2 is a back view of the present invention.

FIG. 3 is a front elevated perspective view of the present invention.

FIG. 4 is a front view of the present invention.

FIG. 5 is a front view of the present invention in use as a scarf.

FIG. 6 is a front view of the present invention in use as a poncho.

FIG. 7 is a combined front and back view of the present invention in use as a strapless dress.

FIG. 8 is a combined front and back view of the present invention in use as a wrap skirt.

FIG. 9 is a combined front and back view of the present invention in use as a halter tie.

FIG. 10 is a combined front and back view of the present invention in use as a vest dress.

FIG. 11 is a front view of the present invention in use as a cape.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a multi-purpose, convertible garment which provides the wearer with protection from damaging ultraviolet rays from the sun. The present invention is easily convertible amongst multiple garments for various implementations of continuous sun coverage for the wearer.

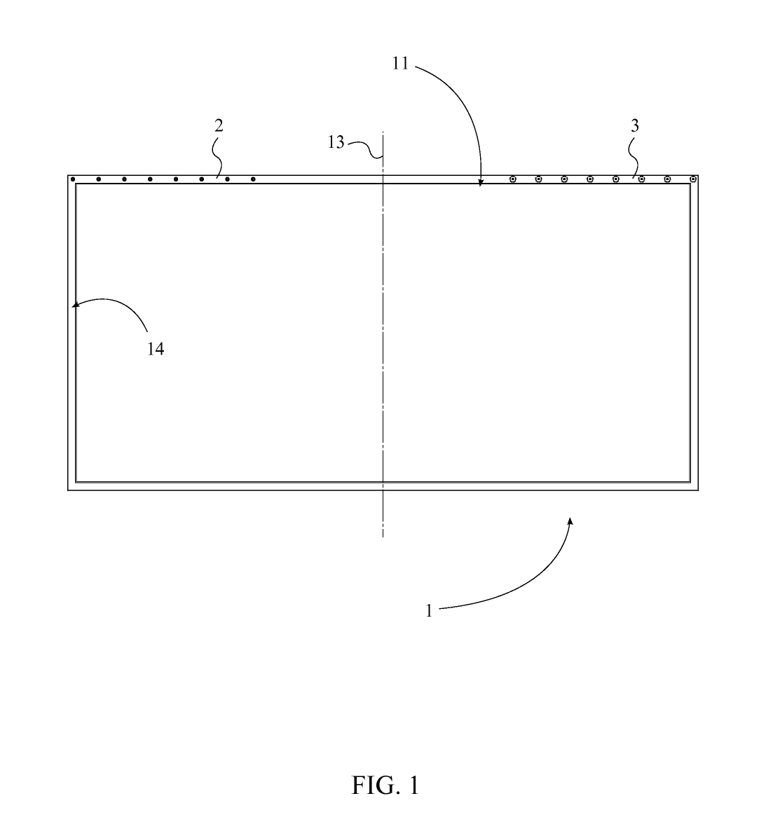

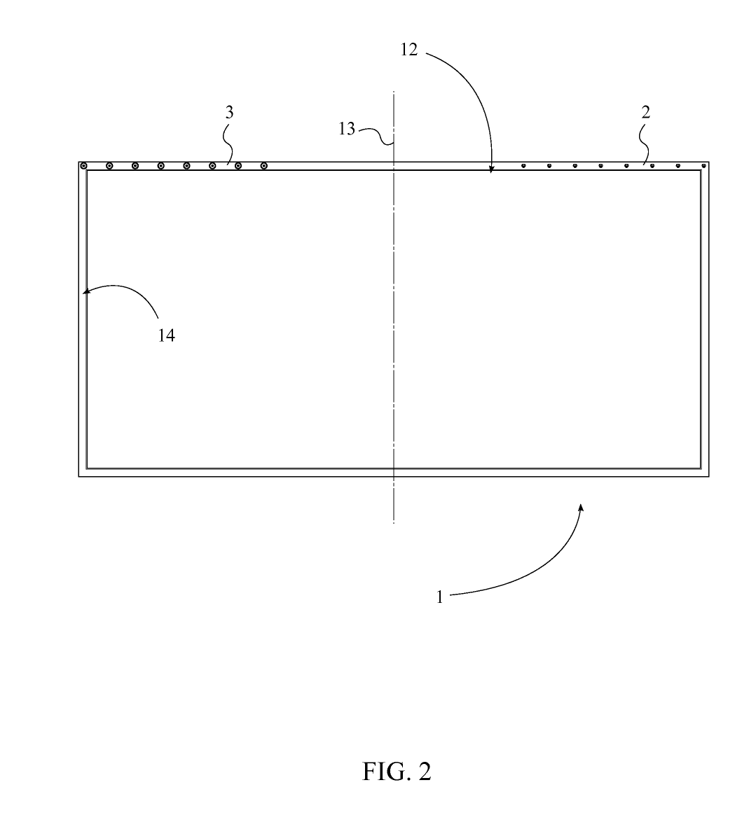

Referring to FIGS. 1-2, the present invention generally comprises a fabric sheet 1, a first fastening strip 2 and a second fastening strip 3. The fabric sheet 1 is the main body of the present invention and comprises a first surface 11, a second surface 12, a central axis 13, and a perimeter 14. It should be understood that the fabric sheet 1 is extremely capable of folding over on itself, and as such geometrical descriptions of the present invention refer to an arrangement of the present invention wherein the fabric sheet 1 is completely flat.

The first surface 11 and the second surface 12 are positioned opposite each other through the fabric sheet 1. In other words, the first surface 11 and the second surface 12 are the two opposing faces of the fabric sheet 1. In the preferred embodiment of the present invention the fabric sheet 1 is made of ultraviolet ray blocking material 200. Furthermore, properties of the ultraviolet ray blocking material 200 include being lightweight, moisture wicking, and breathable, as well as preferably soft and pleasing to the touch. The ultraviolet ray blocking material 200 should block at least 97 percent of UVA and UVB rays. However various ultraviolet protection ratings may be utilized.

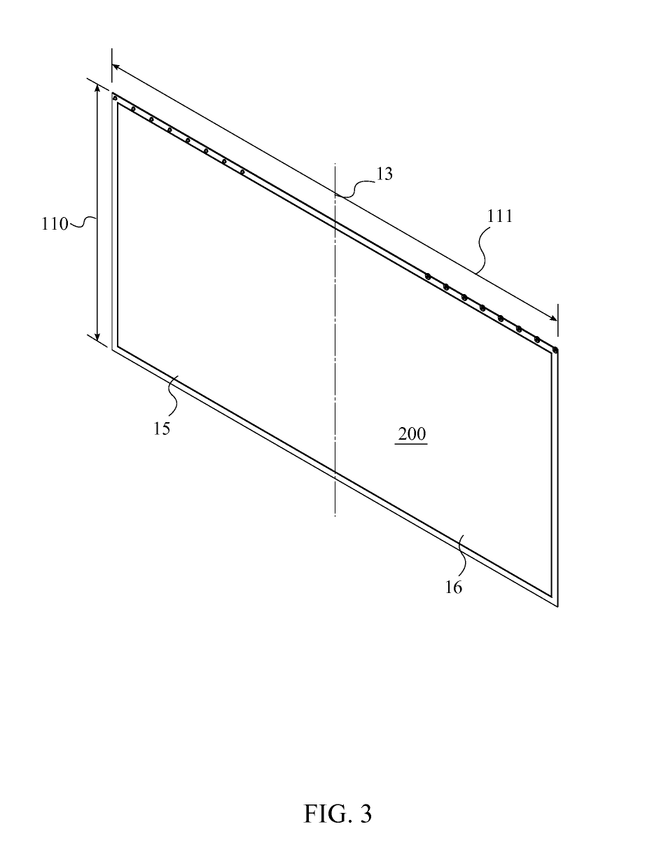

Referring to FIG. 3, a first sheet half 15 of the fabric sheet 1 and a second sheet half 16 of the fabric sheet 1 are positioned adjacent to and coplanar with each other on the fabric sheet 1. The first sheet half 15 and the second sheet half 16 are positioned symmetrically about the central axis 13, wherein the central axis 13 bisects the fabric sheet 1. The first sheet half 15 and the second sheet half 16 each comprise half of the first surface 11 and half of the second surface 12.

In the preferred embodiment of the present invention, the fabric sheet 1 has a rectangular shape with a height dimension 110 and a width dimension 111, wherein the height dimension 110 and the width dimension 111 are perpendicular to each other. The width dimension 111 and the height dimension 110 should each be 20 inches or longer. In the preferred embodiment of the present invention, the height dimension 110 is 30 inches and the width dimension 111 is 60 inches, though other dimensions may be comprised as long as the height dimension 110 and the width dimension 111 are greater than 20 inches.

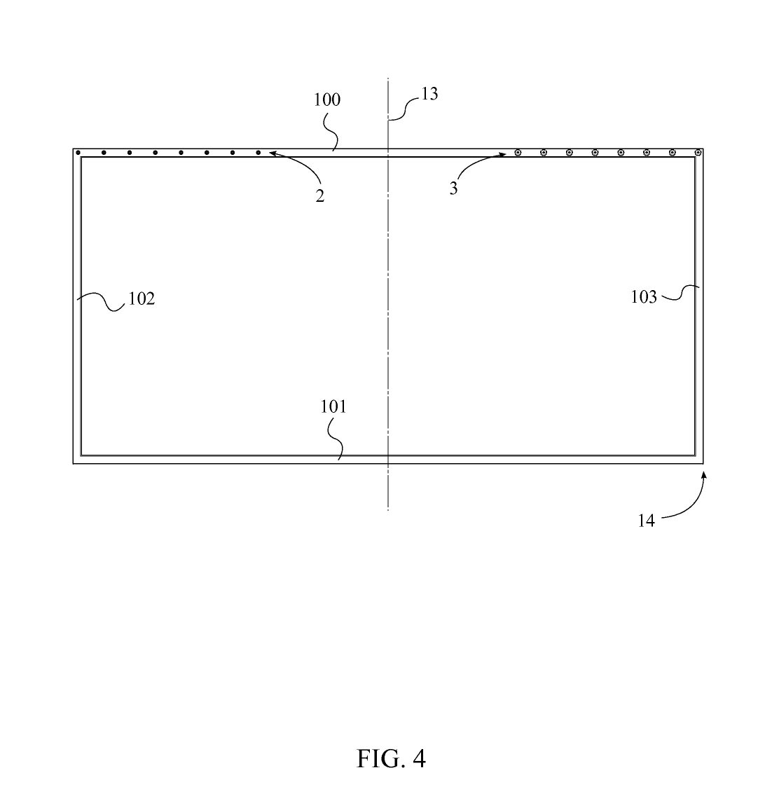

Referring to FIG. 4, the perimeter 14 of the fabric sheet 1 comprises a first edge 100, a second edge 101, a third edge 102, and a fourth edge 103. The first edge 100 and the second edge 101 are positioned parallel to each other and opposite each other on the fabric sheet 1, wherein the first edge 100 and the second edge 101 each delineate the width dimension 111 for the fabric sheet 1, and wherein the first edge 100 and the second edge 101 are each bisected by the central axis 13. Similarly, the third edge 102 and the fourth edge 103 are positioned parallel to each other and opposite each other on the fabric sheet 1, wherein the third edge 102 and the fourth edge 103 each delineate the height dimension 110 for the fabric sheet 1, and wherein the third edge 102 and the fourth edge 103 are equidistant from the central axis 13. The first edge 100 and the second edge 101 are oriented perpendicular to the third edge 102 and the fourth edge 103.

In the preferred embodiment of the present invention, the first fastening strip 2 is connected to the first surface 11, and the second fastening strip 3 is connected to the second surface 12. In the preferred embodiment, the first fastening strip 2 and the second fastening strip 3 are positioned symmetrically about the central axis 13, and adjacent to the perimeter 14. This positioning allows the user to fasten the third edge 102 and the fourth edge 103 together in various configurations ways in order to utilize and wear the present invention in a variety of ways. The first fastening strip 2 and the second fastening strip 3 should be modular and able to fasten to each other at various locations in order to facilitate the customization and configuration of the present invention for use. It is contemplated that in an alternate embodiment, the first fastening strip 2 and the second fastening strip 3 are each replaced by a single fastener, but this is not desired in the preferred embodiment. In the preferred embodiment of the present invention, the first fastening strip 2 is positioned along the first edge 100 adjacent to the third edge 102, traversing along the first edge 100 from the third edge 102 toward the central axis 13. Similarly, the second fastening strip 3 is positioned along the first edge 100 adjacent to the fourth edge 103, traversing along the first edge 100 from the fourth edge 103 toward the central axis 13. As previously mentioned, the first fastening strip 2 is positioned on the first surface 11, and the second fastening strip 3 is positioned on the second surface 12. Thus, attaching the first fastening strip 2 to the second fastening strip 3 results in the first surface 11 being attached to the second surface 12 along a portion of the first edge 100.

In the preferred embodiment of the present invention, the first fastening strip 2 traverses not more than two thirds of the length from the third edge 102 to the central axis 13, and the second fastening strip 3 traverses not more than two thirds of the length from the fourth edge 103 to the central axis 13. In the embodiment where the width dimension 111 is 60 inches, this results in the first fastening strip 2 and the second fastening strip 3 each being 20 inches in length or less. Additionally, it is contemplated that the first fastening strip 2 and the second fastening strip 3 may be positioned in various alternate locations relative to each other, such as, but not limited to, on the first edge 100 and the second edge 101, on the third edge 102 and the fourth edge 103, both on either the first surface 11 or the second surface 12, or at a specified distance away from the perimeter 14, or a combination of the aforementioned positions.

The first fastening strip 2 and the second fastening strip 3 may comprise a variety of embodiments of different fasteners and fastening means. Fasteners comprised in the first fastening strip 2 and the second fastening strip 3 may include, but are not limited to, snaps, zippers, hook and loop tape, buttons, magnets, clamps, clasps, hooks, or any other usable and appropriate fasteners.

In the preferred embodiment, the first fastening strip 2 comprises a plurality of male snaps 4 and the second fastening strip 3 comprises a plurality of female snaps 5. Preferably, the plurality of male snaps 4 comprises eight male snaps, and the plurality of female snaps 5 comprises eight female snaps, though other numbers of snaps may be comprises. This embodiment provides the user with a wide variety of options for customization since the first fastening strip 2 and the second fastening strip 3 are not limited to being fully attached to each other or attached fully along the length of the fastening strips. This snap system allows the user to convert the present invention to each desired configuration or style with different snaps or sets of snaps in various rows or configurations. In addition, the snap system allows the present invention to be sized up or down in order to accommodate various body types and sizes.

In another embodiment, the first fastening strip 2 comprises a hook portion of hook and loop tape, commonly known by the brand name Velcro, while the second fastening strip 3 comprises a loop portion of hook and loop tape. This embodiment may provide additional convenience to the user for attaching the first fastening strip 2 and the second fastening strip 3 since the attachment is continuous, not in discrete locations as with male snaps 4 and female snaps 5, facilitating ease of attachment and removal.

In a third embodiment, the first fastening strip 2 and the second fastening strip 3 each comprise a zipper half, with a zipper slider being positioned on either the zipper half of the first fastening strip 2 or the zipper half of the second fastening strip 3. It this embodiment, the present invention is limited to configurations where the ends of the zipper halves are aligned with each other. This third embodiment may comprise any useful or appropriate zipper embodiments, including a two-way zipper.

The present invention is highly configurable which is made possible by the first fastening strip 2 and the second fastening strip 3. A user may easily change the present invention from a scarf to a poncho, dress or skirt and back to a scarf depending on which parts of the body the wearer wants to protect from the sun's damaging rays. For example, the wearer may wrap the present invention around the neck in a simple knot, then when the wearer goes outside into direct sun exposure, the wearer may choose to convert the present invention from a scarf to a poncho to cover the chest, shoulders, arms and a portion of the legs.

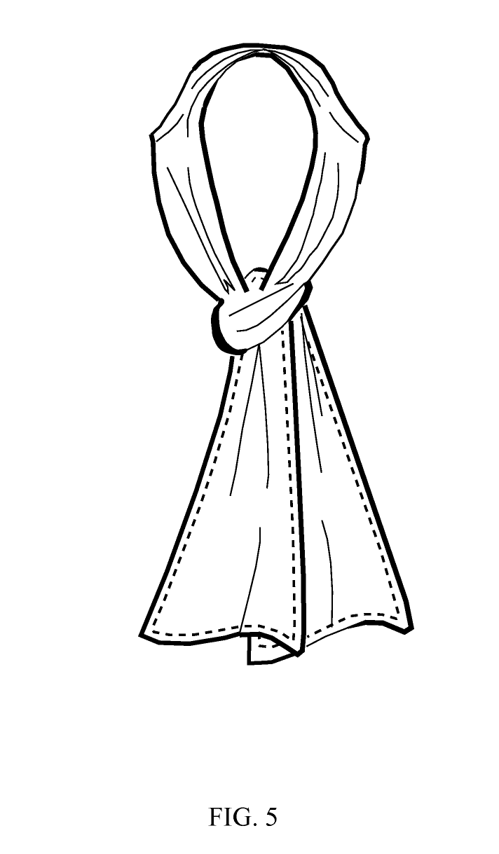

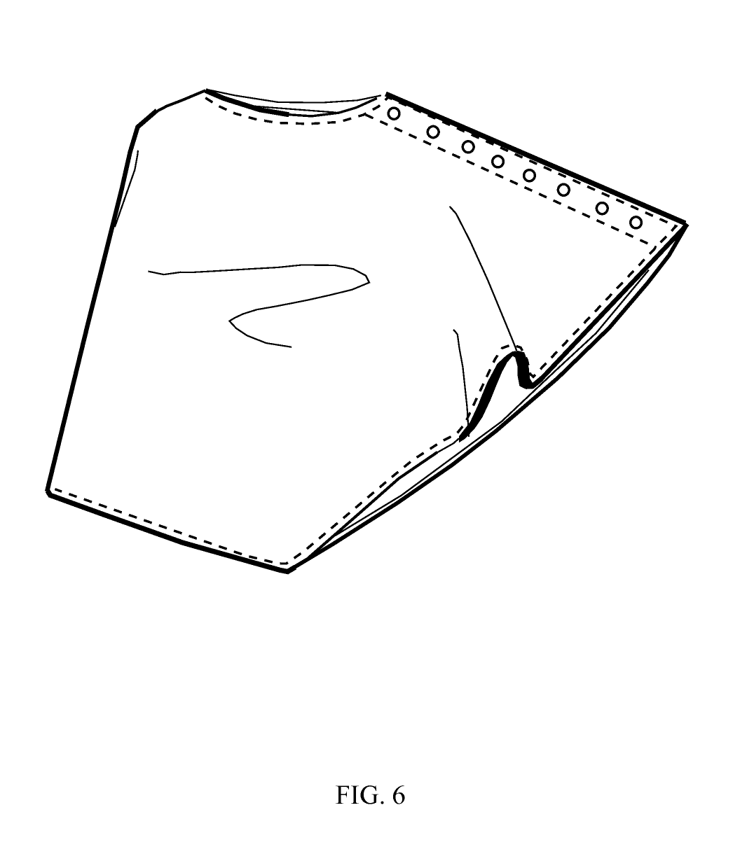

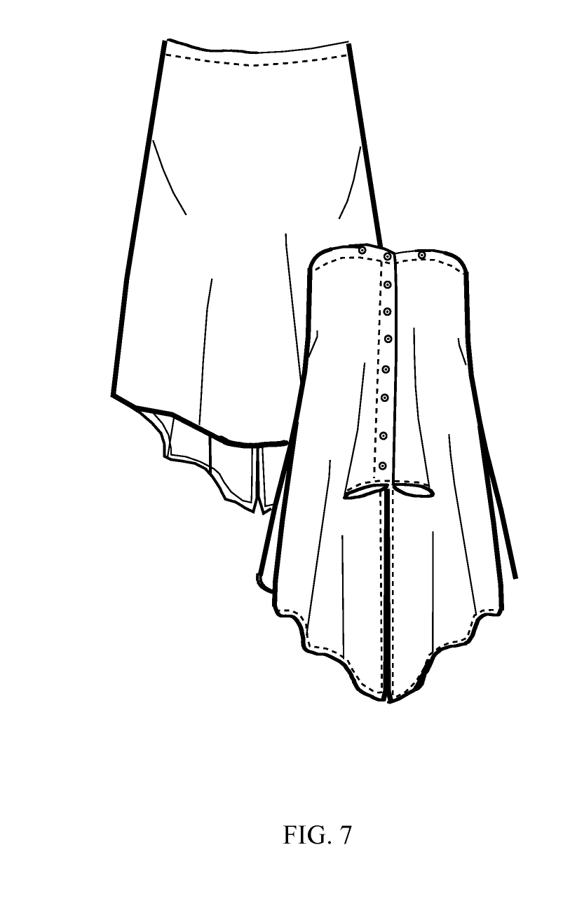

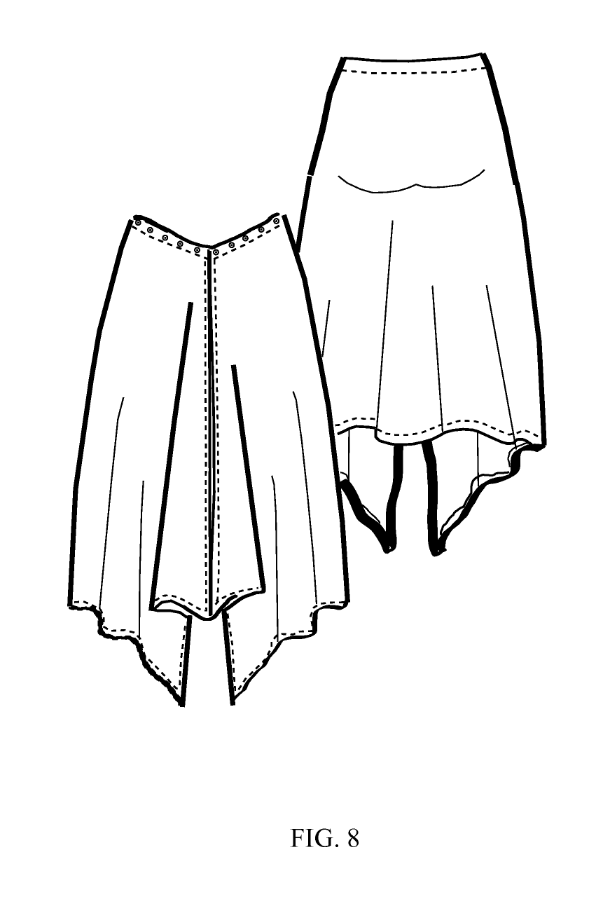

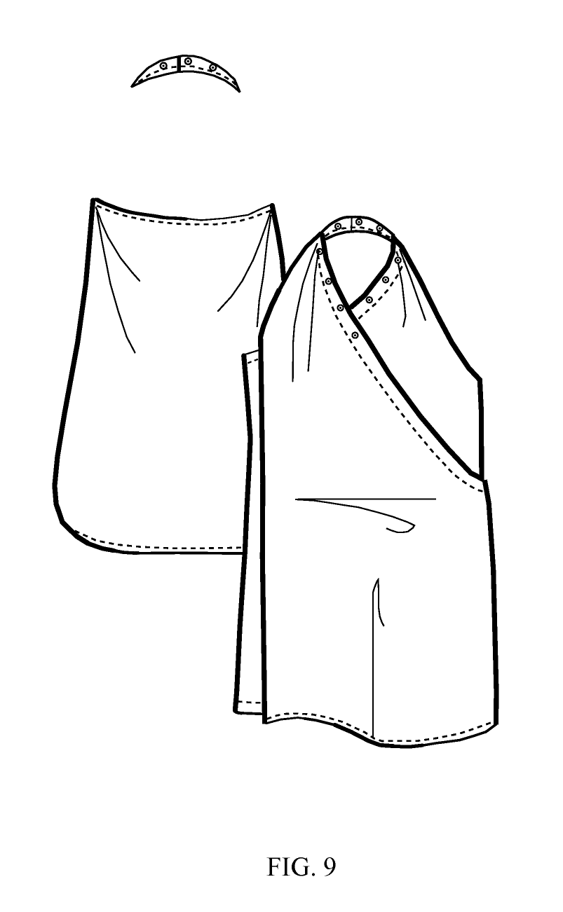

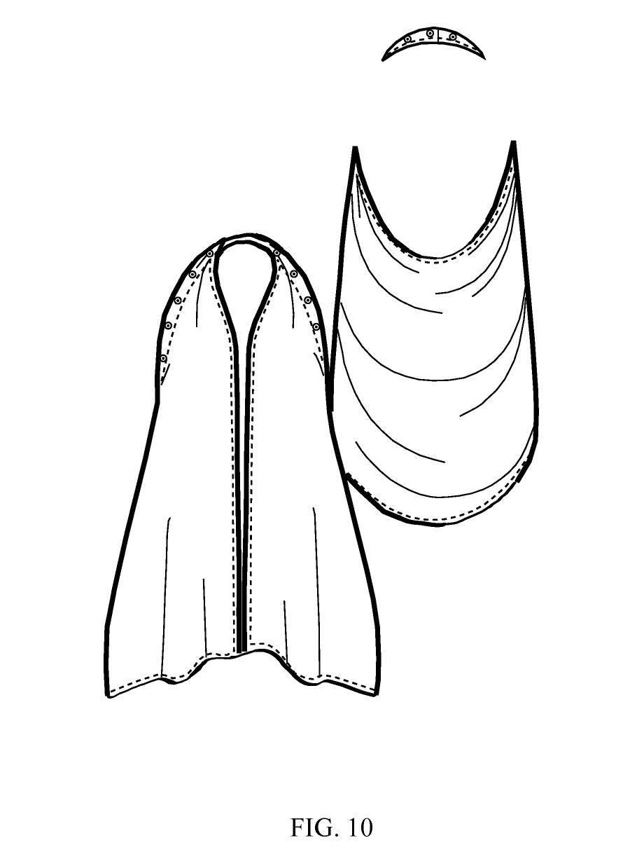

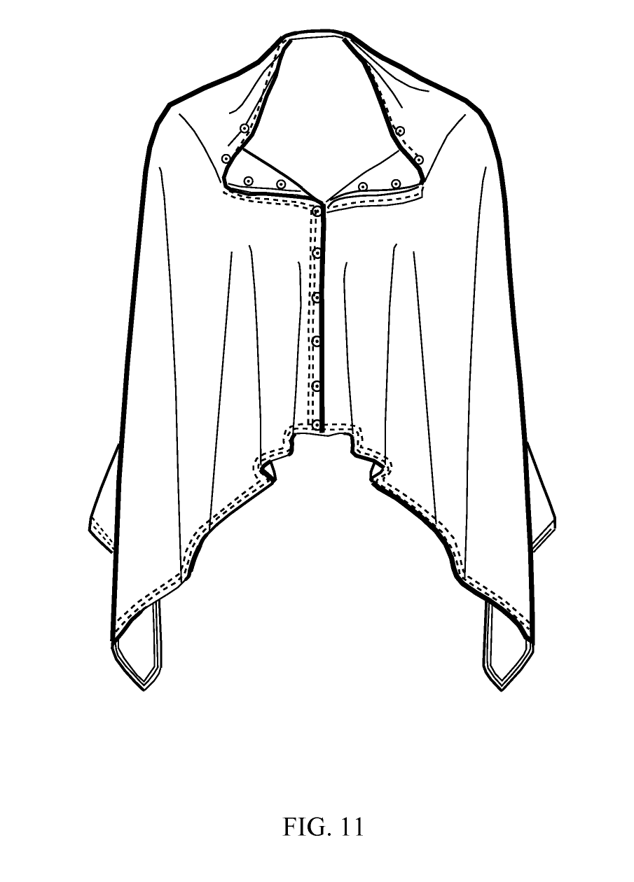

If the wearer wants to cover legs, the wearer may attach the present invention as a long skirt around the waist. If the wearer wants to cover the torso and portion of the legs, the wearer can attach the present invention at the bust. The wearer can achieve torso, chest and leg coverage by fastening the present invention in a halter-tie formation. The wearer can also protect the back of the body by converting the present invention to a long vest. FIGS. 5-11 show various different configurations a user may utilize the present invention as. FIG. 5 shows the present invention in use as a scarf. FIG. 6 shows the present invention in use as a poncho. FIG. 7 shows the present invention in use as a strapless dress. FIG. 8 shows the present invention in use as a wrap skirt. FIG. 9 shows the present invention in use as a halter tie. FIG. 10 shows the present invention in use as a vest dress. FIG. 11 shows the present invention in use as a cape.

Embellishments may be added to the present invention for the purposes of visual aesthetic appeal. The embellishments may be positioned at any desired location on the first surface 11, second surface 12, first edge 100, second edge 101, third edge 102 or fourth edge 103. Additionally, the present invention facilitates the use of an optional hood attachment. In the preferred embodiment, the hood attachment is in the shape of a typical hood as commonly known in clothing, and comprises hood fasteners at lateral ends of the hood in order to attach the hood attachment to the fabric sheet 1. More particularly, in the preferred embodiment where the first fastening strip 2 and the second fastening strip 3 comprise male snaps 4 and female snaps 5, the hood fasteners comprise a corresponding female snap and male snap which may be attached to the male snaps 4 and female snaps 5 of the first fastening strip 2 and the second fastening strip 3. The hood attachment should be attached at the innermost snaps of the present invention, but may be alternately utilized as desired.

Although the invention has been explained in relation to its preferred embodiment, it is to be understood that many other possible modifications and variations can be made without departing from the spirit and scope of the invention as hereinafter claimed.

What is claimed is:

1. A convertible ultraviolet ray protective garment comprises:
a fabric sheet with a first surface, a second surface, a central axis, and a perimeter;
a first fastening strip;
a second fastening strip;
the first surface and the second surface being positioned opposite each other through the fabric sheet;
the first fastening strip being connected to the first surface;
the second fastening strip being connected to the second surface; and
the fabric sheet being made of ultraviolet ray blocking material.

2. The convertible ultraviolet protective garment as claimed in claim 1 comprises:
a first sheet half of the fabric sheet and a second sheet half of the fabric sheet being positioned adjacent to and coplanar with each other on the fabric sheet;
the first sheet half and the second sheet half being positioned symmetrically about the central axis, wherein the central axis bisects the fabric sheet;
the first fastening strip being positioned on the first sheet half; and
the second fastening strip being positioned on the second sheet half.

3. The convertible ultraviolet protective garment as claimed in claim 1 comprises:
the first fastening strip and the second fastening strip being positioned symmetrically about the central axis.

4. The convertible ultraviolet protective garment as claimed in claim 1 comprises:
the first fastening strip and the second fastening strip being positioned adjacent to the perimeter.

5. The convertible ultraviolet protective garment as claimed in claim 1 comprises:
the perimeter comprises a first edge, a second edge, a third edge, and a fourth edge;
the first edge and the second edge being positioned parallel to each other and opposite each other on the fabric sheet,
wherein the first edge and the second edge each delineate a width dimension for the fabric sheet;
wherein the first edge and the second edge are each bisected by the central axis;
the third edge and the fourth edge being positioned parallel to each other and opposite each other on the fabric sheet, wherein the third edge and the fourth edge each delineate a height dimension for the fabric sheet; and
the first edge and the second edge being oriented perpendicular to the third edge and the fourth edge.

6. The convertible ultraviolet protective garment as claimed in claim 4 comprises:
the first fastening strip being positioned along the first edge adjacent to the third edge, wherein the first fastening strip traverses along the first edge from the third edge toward the central axis; and
the second fastening strip being positioned along the first edge adjacent to the fourth edge, wherein the second fastening strip traverses along the first edge from the fourth edge toward the central axis.

7. The convertible ultraviolet protective garment as claimed in claim 5 comprises:
the first fastening strip traversing not more than two thirds of the length from the third edge to the central axis; and
the second fastening strip traversing not more than two thirds of the length from the fourth edge to the central axis.

8. The convertible ultraviolet protective garment as claimed in claim 1 comprises:
the first fastening strip and the second fastening strip each being 20 inches in length.

9. The convertible ultraviolet protective garment as claimed in claim 1 comprises:
the first fastening strip comprises a plurality of male snaps; and
the second fastening strip comprises a plurality of female snaps.

10. The convertible ultraviolet protective garment as claimed in claim 1 comprises:
the first fastening strip and the second fastening strip each comprise a zipper half; and
a zipper slider being positioned on either the zipper half of the first fastening strip or the zipper half of the second fastening strip.

11. The convertible ultraviolet protective garment as claimed in claim 1 comprises:
the first fastening strip comprises a hook portion of hook and loop tape; and
the second fastening strip comprises a loop portion of hook and loop tape.

12. The convertible ultraviolet protective garment as claimed in claim 1 comprises:
the ultraviolet ray blocking material being lightweight.

13. The convertible ultraviolet protective garment as claimed in claim 1 comprises:
the ultraviolet ray blocking material having moisture wicking properties.

14. The convertible ultraviolet protective garment as claimed in claim 1 comprises:
the ultraviolet ray blocking material being breathable.

15. The convertible ultraviolet protective garment as claimed in claim 1 comprises:
the fabric sheet having a rectangular shape with a height dimension and a width dimension, wherein the height dimension and the width dimension are perpendicular to each other.

16. The convertible ultraviolet protective garment as claimed in claim 14 comprises:
the width dimension being 20 inches or longer.

17. The convertible ultraviolet protective garment as claimed in claim 14 comprises:
the height dimension being 20 inches or longer.

18. The convertible ultraviolet protective garment as claimed in claim 14 comprises:
the height dimension being 30 inches.

19. The convertible ultraviolet protective garment as claimed in claim 14 comprises:
the width dimension being 60 inches.
